(19) United States
(12) Patent Application Publication
(10) Pub. No.: US 2005/0018771 A1
(43) Pub. Date: Jan. 27, 2005

(54) Drift-free video encoding and decoding method and corresponding devices

(76) Inventors: Arnaud Bourge, Paris (FR); Eric Barrau, Puteaux (FR)

Correspondence Address: PHILIPS INTELLECTUAL PROPERTY & STANDARDS, P.O. BOX 3001, BRIARCLIFF MANOR, NY, 10510, US

(21) Appl. No.: 10/501,825

(22) PCT Filed: Jan. 20, 2003
(86) PCT No.: PCT/IB03/00156

(30) Foreign Application Priority Data
Jan. 22, 2002 (EP) 02290155.7

(51) Int. Cl. H04N 7/12

(52) U.S. Cl. 375/240.16; 375/240.12; 375/240.25; 375/240.11

(57) ABSTRACT

The invention relates to a video encoding method for the compression of a video sequence, comprising the steps of generating from the original video sequence, by means of a wavelet decomposition, a low resolution sequence, performing on said low resolution sequence a low resolution decomposition, by means of a motion compensated spatio-temporal analysis, generating from said low resolution decomposition a full resolution sequence, by means of an anchoring of the high frequency sparial subbands resulting from the wavelet decomposition to said low resolution decomposition and coding said full resolution sequence and the motion vectors generated during the motion compensated spatio-temporal analysis. The invention also relates to a corresponding decoding method, and to corresponding encoding and decoding devices.

### FIELD OF THE INVENTION

The present invention relates to an encoding method for the compression of an original video sequence divided into successive groups of frames (GOFs) and to a corresponding decoding method. It also relates to corresponding encoding and decoding devices.

### BACKGROUND OF THE INVENTION

The growth of the Internet and advances in multimedia technologies have enabled new applications and services. Many of them not only require coding efficiency but also enhanced functionality and flexibility in order to adapt to varying network conditions and terminal capabilities. Scalability answers these needs. Current video compression standards often use so-called hybrid solutions, based on a predictive scheme where each frame is temporally predicted from a reference frame (the prediction options being: zero value prediction, for the intra frames or I frames, forward prediction, for the P frames, or bi-directional prediction, for the B frames) and the obtained prediction error is spatially transformed to get advantage of spatial redundancies. From MPEG-2 to MPEG-4, standard-based scalable solutions have then been proposed. They rely on the generation of a base layer, containing the lowest spatial, temporal and/or SNR resolution version of the original video sequence, and one or several enhancement layers allowing (if transmitted and decoded) a spatially, temporally and/or SNR refined reconstruction. A short-coming of these layer-based scalability schemes comes however from their lack of coding efficiency.

A different approach has been proposed with techniques such as three-dimensional (3D) subband coding, which are able to generate embedded bitstreams. Thanks to their multi-resolution analysis structure, scalability is inherent to these schemes and does not weaken their intrinsic coding efficiency. In a 3D subband codec such as described for example in “A fully scalable 3D subband video codec”, “Proceedings of the International Conference on Image Processing (ICIP2001), vol.2, 2001, pp.1017-1020, the embedded bitstream is fully scalable and can be decoded at any spatial and temporal resolutions, and with any desired SNR quality, simply by truncation at known locations. In such a scheme, successive groups of frames (GOFs) are processed as a 3D structures and spatio-temporally filtered in order to compact the energy in the low frequencies, a motion compensation being also provided in order to improve the overall coding efficiency. The 3D subband structure is depicted in FIG. 1: the illustrated 3D wavelet decomposition with motion compensation is applied to a group of frames (GOF), and this current GOF is first motion-compensated (MC), in order to process sequences with large motion, and then temporally filtered (TF) using Haar wavelets (the dotted arrows correspond to a high-pass temporal filtering, while the other ones correspond to a low-pass temporal filtering). After the motion compensation operation and the temporal filtering operation, each temporal subband is spatially decomposed into a spatio-temporal subband, which finally leads to a 3D wavelet representation of the original GOF, three stages of decomposition being shown in the example of FIG. 1 (L and H=first stage; LL and LH=second stage; LLL and LLH=third stage).The well known SPIRT algorithm, extended from 2D to 3D, is chosen in order to efficiently encode the final coefficient bit-planes with respect to the spatio-temporal decomposition structure.

As it is implemented now, a 3D subband codec applies the motion-compensated (MC) spatio-teniporal analysis at the full original resolution at the encoder side. Spatial scalability is achieved by getting rid of the highest spatial subbands of the decomposition. However, when motion compensation is used in the 3D analysis scheme, this method does not allow a perfect reconstruction of the video sequence at lower resolution, even at very high bit-rates: this phenomena, referred to as drift in the following description, lowers the visual quality of the scalable solution compared to a direct encoding at the targeted final display size. As explained in the document “Multiscale video compression using wavelet transform and motion compensation”, P. Y. Cheng and al., Proceedings of the International Conference on Image Processing (ICIP95), Vol.1, 1995, pp.606-609, this drift comes from the order of wavelet transform and motion compensation that is not interchangeable. Indeed, when a frame (A) is synthesized at a lower resolution (a), the following operation is applied:

$$\begin{matrix}a = {DWT}_{L} ( L ) + MC [ {DWT}_{L} ( H ) ] \\ = {DWT}_{L} ( A ) + [ MC [ {DWT}_{L} ( H ) ] - {DWT}_{L} ( MC [ H ] ) ]\end{matrix} \qquad ( 1 )$$

where DWT_{L} denotes the resolution downsample using the same wavelet filters as in the 3D analysis. In a perfect scalable solution, one wants to have:
a=DWT_{L}(A) (2)
The remaining part of the expression (1) therefore corresponds to the drift. It can be noticed that, if no MC is applied, the drift is removed. The same phenomena happens (except at the image borders) if a unique motion vector is applied to the frame. Yet, it is known that MC is unavoidable to achieve a good coding efficiency, and the likelihood of a unique global motion is small enough to eliminate this particular case in the following paragraphs.

Some authors, such as J. W. Woods and al in the document “A resolution and frame-rate scalable subband/wavelet video coder”, IEEE Transactions on Circuits and Systems for Video Technology, vol.1, no. 9, September 2001, pp.1035-1044, get rid of this drift to achieve good spatial scalability by different means. However, in said document, the described scheme, in addition to being quite complex, implies the sending of an extra information (the drift correction necessary to correctly synthesize the upper resolution) in the bitstream, thus wasting some bits (the solution described in the document “Multiscale video compression . . . ” avoids this bottleneck but works on a predictive scheme and is not transposable to the 3D subband codec).

### SUMMARY OF THE INVENTION

It is therefore an object of the invention to propose a solution avoiding these drawbacks.

To this end, the invention relates to a video encoding method for the compression of an original video sequence divided into successive groups of frames (GOFs), said method comprising the steps of:
(1) generating from the original video sequence, by means of a wavelet decomposition, a low resolution sequence including successive low resolution GOFs;
(2) performing on said low resolution sequence a low resolution decomposition, by means of a motion compensated spatio-temporal analysis of each low resolution GOF;
(3) generating from said low resolution decomposition a fall resolution sequence, by means of an anchoring of the high frequency spatial subbands resulting from the wavelet decomposition to said low resolution decomposition;
(4) coding said full resolution sequence and the motion vectors generated during the motion compensated spatio-temporal analysis, for generating an output coded bitstream.

The proposed solution is remarkable in the sense that the global structure of the decomposition tree in the 3DS analysis is preserved aid no extra information is sent to correct the drift effect (only the decomposition/reconstruction mechanism is changed). If no motion estimation/compensation is performed at full resolution, it is a low-cost solution in terms of complexity. If motion compensation is introduced in the high spatial subbands, a better coding efficiency is provided.

The invention also relates to a corresponding decoding method, comprising the steps of:
(1) decoding said input coded bitstream for generating a decoded full resolution sequence and associated decoded motion vectors;
(2) in said decoded full resolution sequence, separating the decoded high frequency spatial subbands and the decoded low resolution decomposition;
(3) generating from said decoded low resolution decomposition, by means of a motion compensated spatio-temporal synthesis, a decoded low resolution sequence;
(4) reconstructing from said decoded low resolution sequence and the decoded high frequency spatial subbands an output fall resolution sequence corresponding to the original video sequence.

The invention also relates to an encoding device and a decoding device provided for implementing said encoding method and said decoding method respectively.

### BRIEF DESCRIPTION OF THE DRAWINGS

The invention will now be described in a more detailed manner, with reference to the accompanying drawings in which:

FIG. 1 shows a 3D subband decomposition;

FIG. 2 illustrates a motion-compensated temporal analysis at the lowest resolution;

FIG. 3 depicts an embodiment of an encoding scheme according to the invention;

FIG. 4 depicts an embodiment of a decoding scheme corresponding to the encoding scheme of FIG. 3;

FIG. 5 illustrates the reordering of the high spatial subbands (for a forward motion compensation);

FIG. 6 depicts another embodiment of an encoding scheme according to the invention.

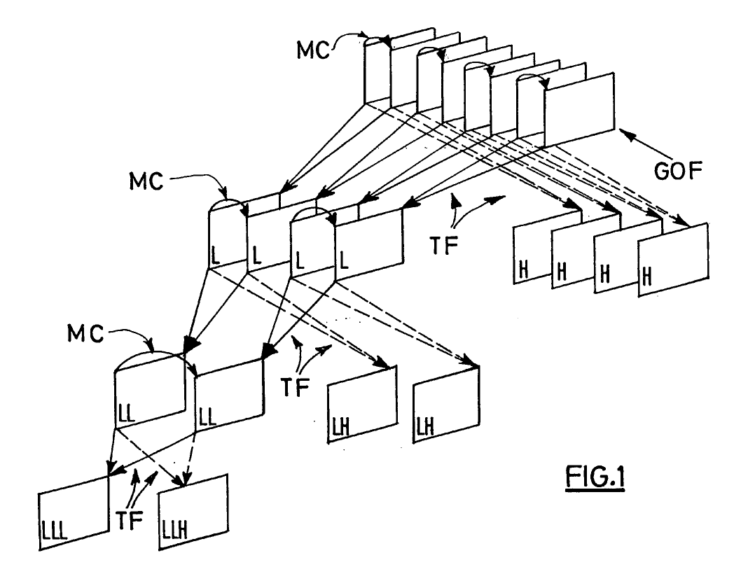

### DETAILED DESCRIPTION OF THE INVENTION

The proposed solution (i.e. a spatial scalability with no drift in a motion compensated 3D subband codec) is now explained with reference to its two main steps: (a) motion compensation at the lowest resolution, (b) encoding the high spatial subbands.

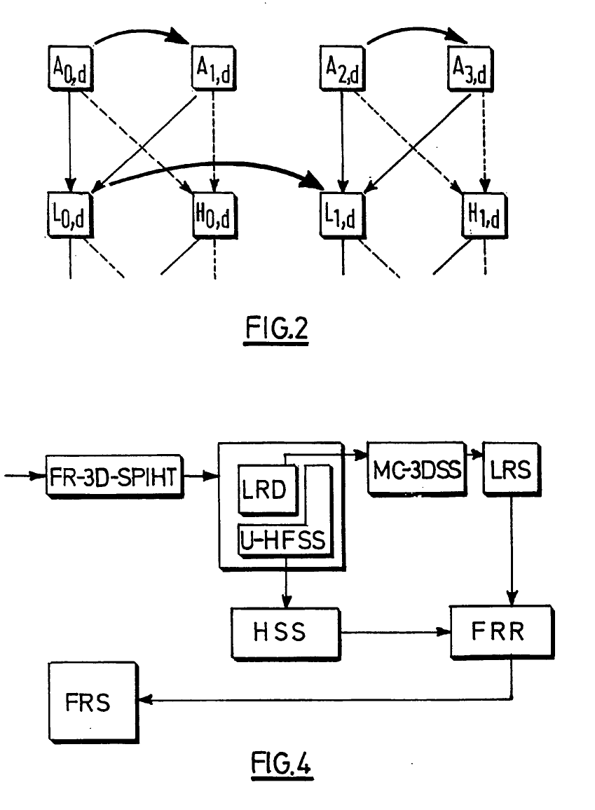

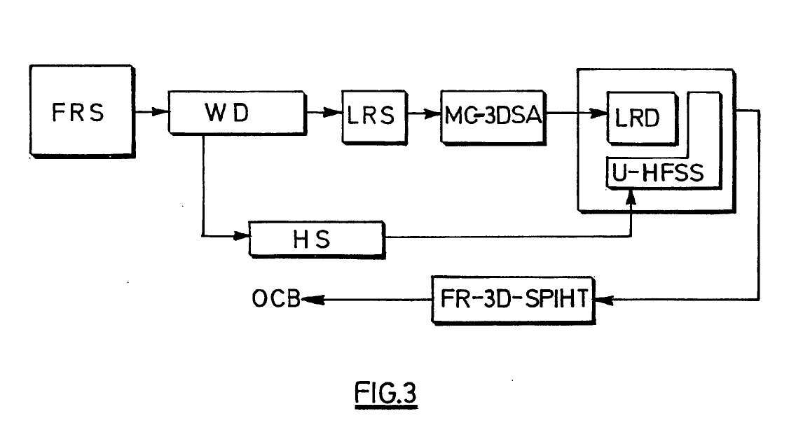

First in order to avoid drift at lower resolutions, Motion Compensation (MC) is applied at this level. Consequently, as illustrated in FIG. 2, one first downsizes (reference d) the GOF using wavelet filters, and the usual 3D subband MC-decomposition scheme is then applied to this downsized GOP instead of the fall-size GOF. In FIG. 2, the temporal subbands (L_{0,d}, H_{0,d}) and (L_{1,d}, H_{1,d}) are determined according to the well-known lifting scheme (H is first defined from A and B, and then L from A and H), and the dotted arrows correspond to the high-pass temporal filtering, the continuous ones to the low-pass temporal filtering, and the curved ones (between low frequency spatial subbands A of the frames of the sequence, referenced A_{0,d}, A_{1,d}, A_{2,d}, A_{3,d}, or between low frequency temporal subbands L, referenced L_{0,d} and L_{1,d}) to the motion compensation (it may be noticed that a side effect of this method is the reduction of the amount of motion vectors to be sent in the bitstream, which saves up some bits for texture coding). Before transmitting the subbands to a tree-based entropy coder (for instance to a 3D-SPIHT encoder such as described for instance in the document “Low bit-rate scalable video coding with 3D set partitioning in hierarchical trees (3D-SPIHT)”, B. J. Kim and al. IEEE Transactions on Circuits and Systems for Video Technology, vol.10, no8, December 2000, pp.1374-1387), one puts the high spatial subbands that allow the reconstruction of the full resolution. The final tree structure looks very similar to that of a 3D subband codec such as the one described in the document “A fully scalable 3D subband video codec”, IEEE Conference on Image Processing (ICIP2001), vol.2, pp.1017-1020, Thessalonili, Greece, Oct. 7-10, 2001, and so a tree-based entropy coder can be applied on it without any restriction, as described in the new encoding scheme of FIG. 3, where the references are the following (for a frame of the full resolution sequence)
FRS: full resolution sequence
WD: wavelet decomposition
LRS: low resolution sequence
MC-3DSA: motion-compensated 3D subband analysis
LRD: low resolution decomposition
HS: high subbands
U-HFSS: union of the three high frequency spatial subbands of a frame
FR-3D-SPMIT: full resolution 3D SPIHT
OCB: output coded bitstream.
   The corresponding decoding scheme, depicted in FIG. 4, is symmetric to this encoder (in FIG. 4, the additional references are the following:
MC-3DSS: motion compensated 3D subband synthesis
HSS: high subbands separation
FRR: full resolution reconstruction).
   To enable spatial scalability, the high frequency spatial subbands just have to be cut as in the usual version of the 3DS codec, the decoding scheme of FIG. 4 showing how to naturally obtain the low resolution sequence.

Then, for coding the high spatial subbands, two main solutions are proposed, the first one without MC, and the second one with MC.

A) Without MC

In the first solution, the high subbands simply correspond to the high frequency spatial subbands of the original (full resolution) frames of the GOF in the wavelet decomposition. Those subbands allow the reconstruction at full resolution at the decoder. Indeed, the frames can be decoded at the low resolution. However, these frames correspond to the low spatial subband in the wavelet analysis of the original frames. Hence one has merely to put the low resolution frames and the corresponding high subbands together and apply a wavelet synthesis to obtains the full resolution frames. But now, where and how to put those high subbands in order to optimize the 3D-SPIHT encoder ? In a MC scheme for a 3D subband encoder, the low temporal subbands always look like one of the original frames of the GOF. As a matter of fact:

$$L = \frac{1}{\sqrt{2}} [ A + MC ( B ) ] \qquad ( 3 )$$

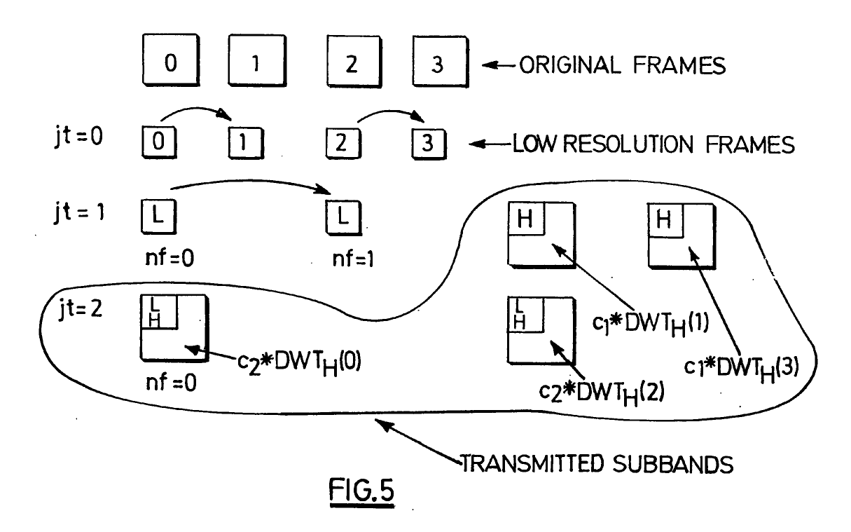

so L looks like A. Consequently, the high spatial subband of A should be placed with the low resolution decomposition corresponding to L. This approach (reordering of the high spatial subband in the case of forward motion compensations) is illustrated in FIG. 5, where DWT_{H} denotes the high frequency wavelet filter and the coefficients cⱼₜ are multiplication coefficients. The way to define cⱼₜ is described later.

However, the motion compensation in the 3D subband structure can be either forward or backward (it has even been shown that alternate directions improve coding efficiency. The following algorithm, in which the notations are:
jt: temporal decomposition level (0 for the full frame-rate, jt_max for the lowest frame-rate)
t: 0 for the low temporal subband, 1 for the high one
nf: subband index at temporal level jt
medir_desc_tree: a byte that describes the ME directions
used at a given temporal level jt (the LSB describes
the direction of the first ME/MC, 0 means “forward”,
1 means “backward”),

makes the link between a frame GOF_index in the GOF and the spatio-temporal subband {jt;n;t} which resembles it most, depending on the Motion Estimation Direction Description Tree.

UInt8
STlocationToGofIndex(MEDirectionDescriptionTree me_dir_desc_{—}
tree, UInt8 jt_max, UInt8 jt, UInt8 nf, UInt8 t)
{

UInt8 gof_index=0 ;
UInt8 direction ;
UInt8 j,n_sb ;
UInt8 sign ;
gof_index = nf<<jt ;
sign = 1 ;
n_sb = nf ;
for (j=jt−1 ; j>=0; j−−)

{

direction = 1<<n_sb ;
if (t==0)
sign=0 ;
direction &= me_dir_desc_tree.aui8_level[j] ;
direction >>= n_sb ;
if (sign)
{

direction = !direction ;
sign = 0 ;

}
n_sb = (n_sb<<1) + direction ;
direction <<=j ;
gof_index = direction;

}

return(gof_index) ;

}

The way to define the coefficients cⱼₜ is now described (in Haar filter case). Let α be the coefficient used in the temporal 2-tap Haar filter. In the conventional 3D subband scheme, one has:

$$\{ \begin{matrix}L = α * ( A + {MC}^{- 1} ( B ) \\ H = α * ( MC ( A ) - B )\end{matrix}$$

If, in the present scheme, one uses cⱼₜ=α^{jt} for the high spatial subbands, then it is still meaningful to use temporal scalability. Indeed:

$$\{ \begin{matrix}{DWT}_{L} ( L ) = α * ( {DWT}_{L} ( A ) + {MC}^{- 1} ( {DWT}_{L} ( B ) ) ) \\ {DWT}_{H} ( L ) = {c}_{jt} * ( {DWT}_{H} ( A ) ) \\ = α * ( {DWT}_{H} ( A + UpSample [ {MC}^{- 1} ( {DWT}_{L} ( B ) ) ] )\end{matrix} \\ \text{and:} \\ \{ \begin{matrix}{DWT}_{L} ( H ) = α * ( {DWT}_{L} ( B ) - MC [ {DWT}_{L} ( A ) ] ) \\ {DWT}_{H} ( H ) = α * ( {DWT}_{H} ( B ) )\end{matrix}$$

where UpSample refers to the picture upsizing using wavelet filters. For the reconstruction at a lower frame rate, only the low temporal subband is synthesized:

$$\{ \begin{matrix}\begin{matrix}\hat{L} = \frac{1}{2 * α} {DWT}^{- 1} [ DWT ( L ) ] \\ = \frac{1}{2} * ( A + UpSample [ {MC}^{- 1} ( {DWT}_{L} ( B ) ) ] )\end{matrix}\end{matrix}$$

Finally, the reconstructed frames at each temporal level will tend to look like a motion-compensated average of the “reference” original frame and a blurred version of the other one (up-sampled version of the downsized frame), whereas in the current version of the 3D subband codec this blur is not introduced. Improving spatial scalability at the expense of adding blur in the temporal scalability is however a worthy step.
B) With MC

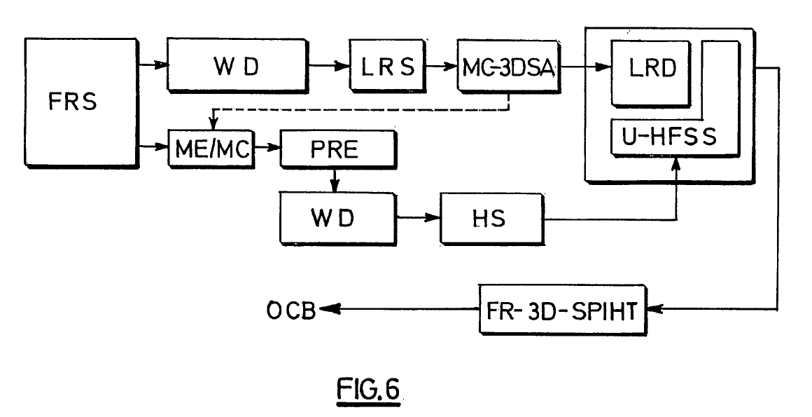

As using MC in every subband does not allow a reconstruction with no drift, it is possible, as depicted in FIG. 6, to partially use MC to construct the high spatial subbands (which is better in terms of coding efficiency) and still be able to reconstruct every resolution (in FIG. 6, the additional references are the following:
ME/MC: motion estimation/motion compensation
PRE: prediction error).
   Instead of directly using the high frequency spatial subbands of the wavelet decomposition, a wavelet decomposition is carried out on a prediction error obtained from the MC performed on the full resolution sequence and reusing for instance the motion vectors of the low resolution.

The solution is to define:

$$\{ \begin{matrix}{DWT}_{H} ( L ) = {c}_{jt} * ( {DWT}_{H} ( A ) ) \\ {DWT}_{H} ( H ) = {c}_{jt} * {DWT}_{H} ( B - MC ( A ) )\end{matrix}$$

It can be noticed that the MC is only used in the high temporal subband: A is first reconstructed at the full resolution thanks to the low temporal subband, and then used to get frame B with MC thanks to H. The coefficients cⱼₜ are chosen as previously. Said MC at full resolution can be performed either by merely upsampling the low resolution motion vectors (which has the advantage of introducing no other motion vector overhead) or by refining these upsampled low resolution vectors (which costs some additional transmission bits but is more efficient in terms of texture coding).

It must be understood that the present invention is not limited to the aforementioned embodiments, and variations and modifications may be made without departing from the spirit and scope of the invention. There are numerous ways of implementing functions of the method according to the invention by means of items of hardware or software, or both, provided that a single item of hardware or software can carries out several functions. It does not exclude that an assembly of items of hardware or software or both carry out a function, thus forming a single function without modifying the method in accordance with the invention. Said hardware or software items can be implemented in several manners, such as by means of wired electronic circuits or by means of an integrated circuit that is suitable programmed. The integrated circuit can be contained in a computer or in an encoder or decoder and comprise a set of instructions, contained, for example, in a computer programming memory or in an encoder or decoder memory and causing the computer or the decoder to carry out the different steps of the methods according to the invention. This set of instructions may be loaded into the programming memory by reading a data carrier such as, for example, a disk. A service provider can also make the set of instructions available via a communication network such as, for example, the Internet.

1. A video encoding method for the compression of an original video sequence divided into successive groups of frames (GOFs), said method comprising the steps of:
(1) generating from the original video sequence, by means of a wavelet decomposition, a low resolution sequence including successive low resolution GOFs;
(2) performing on said low resolution sequence a low resolution decomposition, by means of a motion compensated spatio-temporal analysis of each low resolution GOF;
(3) generating from said low resolution decomposition a full resolution sequence, by means of an anchoring of the high frequency spatial subbands resulting from the wavelet decomposition to said low resolution decomposition;
(4) coding said full resolution sequence and the motion vectors generated during the motion compensated spatio-temporal analysis, for generating an output coded bitstream.

2. A method according to claim 1, in which, for each frame, said high spatial subbands are directly anchored to the low resolution subband that, in said spatio-temporal decomposition, looks most like said frame, depending on the motion estimation direction.

3. A method according to claim 1, in which a predictive mode is used to construct the high spatial subbands, said high spatial subbands resulting from a second wavelet decomposition performed on a prediction error obtained from a motion compensation applied to the original video sequence.

4. An encoding device for the implementation of the video encoding method according to claim 1.

5. A method for decoding an input bitstream coded by means of an encoding method according to claim 1, said decoding method comprising the steps of:
(1) decoding said input coded bitstream for generating a decoded full resolution sequence and associated decoded motion vectors;
(2) in said decoded full resolution sequence, separating the decoded high frequency spatial subbands and the decoded low resolution decomposition;
(3) generating from said decoded low resolution decomposition, by means of motion compensated spatio-temporal synthesis, a decoded low resolution sequence;
(4) reconstructing from said decoded low resolution sequence and the decoded high frequency spatial subbands an output full resolution sequence corresponding to the original video sequence.

6. A decoding device for the implementation of the video decoding method according to claim 5.
